(19) United States
(12) Patent Application Publication
(10) Pub. No.: US 2012/0116675 A1
(43) Pub. Date: May 10, 2012

(54) Navigation on Maps of Irregular Scales or Variable Scales

(75) Inventor: Michael A. Iles, Ottawa (CA)

(73) Assignee: International Business Machines Corporation, Armonk, NY (US)

(21) Appl. No.: 13/023,167

(22) Filed: Feb. 8, 2011

(30) Foreign Application Priority Data
Nov. 10, 2010 (CA) 2719928

(51) Int. Cl. G09G 5/377; G01C 21/00

(52) U.S. Cl. 701/455; 345/636; 701/533

(57) ABSTRACT

An illustrative embodiment of a computer-implemented method for projecting geographic coordinates into a coordinate space of a target image enabling navigation of the target image is presented which performs an initialization using a set of geographic reference points, receives a set of points in the coordinate space of the target image, receives a one-to-one mapping between the set of geographic reference points and the set of points in the coordinate space of the target image, computes a triangulation of the geographic reference points of each respective set of geographic reference points, identifies a containing triangle represented in the triangulation in which an arbitrary geographic coordinate point is located, identifies points in a space of the target image corresponding to vertices of the containing triangle, interpolates a location within the containing triangle to form a resulting location and superimposes the resulting location onto the target image.

### BACKGROUND

This disclosure relates generally to geo-referencing in a data processing system and more specifically for projecting geographic coordinates into an a coordinate space of a target image using the data processing system.

Typically an arbitrary map has a characteristic of either the map projection is not known, or the map does not conform to a regular projection. Examples of such maps include air photos, tourist maps such as maps of a downtown area, or a theme park, hand-drawn maps or location sketches, historical maps, scans or photographs of paper maps, historical landscape photos, schematics not-to-scale, and detailed maps for athletic activities such as those used in mountain biking or orienteering.

A map user using a location-aware mobile device would like to see a representation of a current position superimposed on the arbitrary type map, to aid in navigation. A current solution to the navigation typically forces the image of the map to conform to a regular projection and accordingly distorts the image. The process is known as ortho-correction and has the effect of distorting the original image, which in the case of the previous example maps typically either destroys the aesthetic value of the maps or in some cases renders the resulting ortho-corrected image unrecognizable. For example, using ortho-correction may result in an extreme change in scale across the original map.

### SUMMARY

According to one embodiment, a computer-implemented method for projecting geographic coordinates into a coordinate space of a target image enabling navigation of the target image performs an initialization using a set of geographic reference points, receives a set of points in the coordinate space of the target image, receives a one-to-one mapping between the set of geographic reference points and the set of points in the coordinate space of the target image, computes a triangulation of the reference geographic points of each respective set of geographic reference points, identifies a containing triangle represented in the triangulation in which an arbitrary geographic coordinate point is located, identifies points in a space of the target image corresponding to vertices of the containing triangle, interpolates a location within the containing triangle to form a resulting location and superimposes the resulting location onto the target image.

According to another embodiment, a computer program product for projecting geographic coordinates into a coordinate space of a target image enabling navigation of the target image comprises a computer recordable-type media containing computer executable program code stored thereon. The computer executable program code comprises computer executable program code for performing an initialization using a set of geographic reference points, computer executable program code for receiving a set of points in a coordinate space of a target image, computer executable program code for receiving a one-to-one mapping between the set of geographic reference points and the set of points in the coordinate space of the target image, computer executable program code for computing a triangulation of the geographic reference points of each respective set of geographic reference points, computer executable program code for identifying a containing triangle represented in the triangulation in which an arbitrary geographic coordinate point is located, computer executable program code for identifying points in a space of the target image corresponding to vertices of the containing triangle, computer executable program code for interpolating a location within the containing triangle to form a resulting location and computer executable program code for superimposing the resulting location onto the target image.

According to another embodiment, an apparatus for projecting geographic coordinates into a coordinate space of a target image enabling navigation of the target image, comprises a communications fabric, a memory connected to the communications fabric, wherein the memory contains computer executable program code, a communications unit connected to the communications fabric, an input/output unit connected to the communications fabric, a display connected to the communications fabric and a processor unit connected to the communications fabric. The processor unit executes the computer executable program code to direct the apparatus to perform an initialization using a set of geographic reference points, receive a set of points in a coordinate space of a target image, receive a one-to-one mapping between the set of geographic reference points and the set of points in the coordinate space of the target image, compute a triangulation of the geographic reference points of each respective set of geographic reference points, identify a containing triangle represented in the triangulation in which an arbitrary geographic coordinate point is located, identify points in a space of the target image corresponding to vertices of the containing triangle, interpolate a location within the containing triangle to form a resulting location and superimpose the resulting location onto the target image.

These and other features and advantages of the present invention will be described in, or will become apparent to those of ordinary skill in the art in view of the following detailed description of the example embodiments of the present invention.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 is a block diagram of an exemplary data processing system network operable for various embodiments of the disclosure;

FIG. 2 is a block diagram of an exemplary data processing system operable for various embodiments of the disclosure;

FIG. 3 is a block diagram of a projection system, in accordance with various embodiments of the disclosure;

FIG. 4 is pictorial representation of a geo-referenced map and an arbitrary map, in accordance with one embodiment of the disclosure;

FIG. 5 is a pictorial representation of a geo-referenced map and an arbitrary map, in accordance with one embodiment of the disclosure;

FIG. 6 is a pictorial representation of a geo-referenced map and an arbitrary map, in accordance with one embodiment of the disclosure;

FIG. 7 is a pictorial representation of a geo-referenced map and an arbitrary map, in accordance with one embodiment of the disclosure; and

FIG. 8 is a flowchart of a process for projecting geographic coordinates into a coordinate space of a target image, in accordance with an embodiment of the disclosure.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with the computer-readable program code embodied therein, for example, either in baseband or as part of a carrier wave. Such a propagated signal may take a variety of forms, including but not limited to electro-magnetic, optical or any suitable combination thereof, A computer readable signal medium may be any computer readable medium that is not a computer readable storage medium and that can communicate, propagate, or transport a program for use by or in connection with an instruction execution system, apparatus, or device.

Program code embodied on a computer-readable medium may be transmitted using any appropriate medium, including but not limited to wireless, wire line, optical fiber cable, RF, etc, or any suitable combination of the foregoing.

Computer program code for carrying out operations for aspects of the present disclosure may be written in any combination of one or more programming languages, including an object oriented programming language such as Java®, Smalltalk, C-++, or the like and conventional procedural programming languages, such as the “C” programming language or similar programming languages as well as Web-based programming language or scripting languages such as JavaScript™. Java and all Java-based trademarks and logos are trademarks of Oracle Corporation and/or its affiliates, in the United States, other countries or both. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus, (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or other programmable data processing apparatus to function in a particular manner, such that the instructions stored in the computer readable medium produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

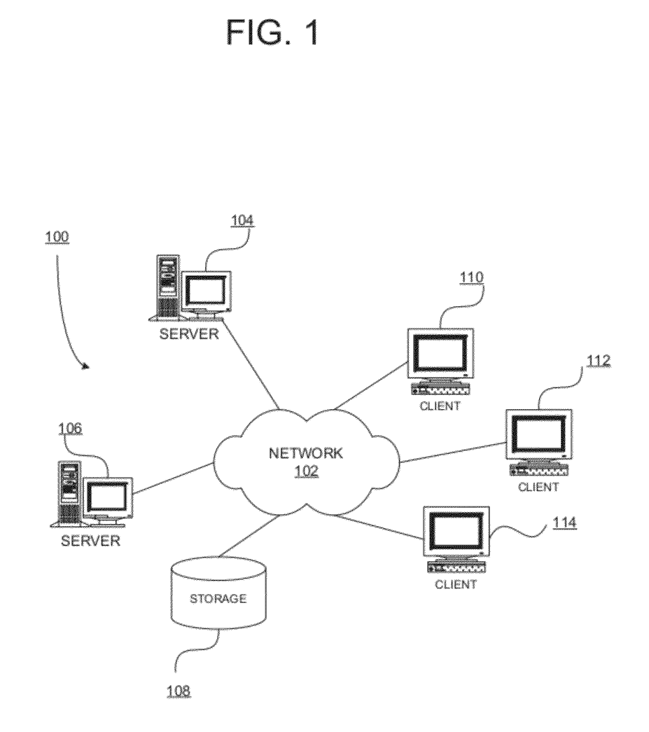

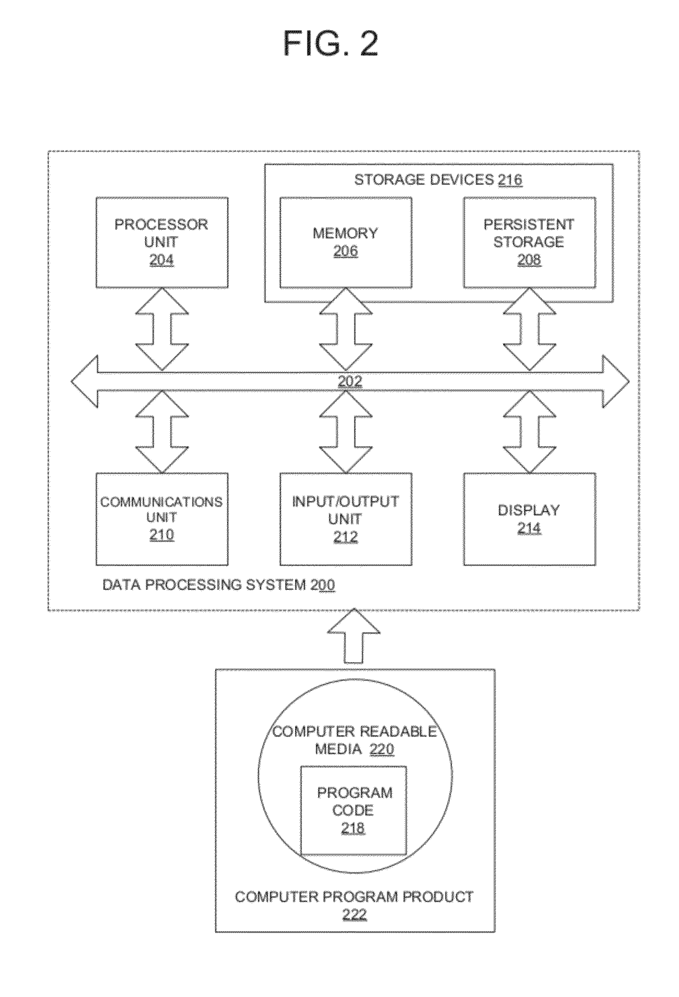

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference to FIG. 2 a block diagram of an exemplary data processing system operable for various embodiments of the disclosure is presented. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications fabric 202. In these illustrative examples the instructions are in a functional form on persistent storage 208. These instructions may be loaded into memory 206 for execution by processor unit 204. The processes of the different embodiments may be performed by processor unit 204 using computer-implemented instructions, which may be located in a memory, such as memory 206.

These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 220 also may take the form of a persistent storage, such as a hard drive, a thumb drive, or a flash memory that is connected to data processing system 200. The tangible form of computer readable media 220 is also referred to as computer recordable storage media. In some instances, computer readable media 220 may not be removable.

Alternatively, program code 218 may be transferred to data processing system 200 from computer readable media 220 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

Using data processing system 200 of FIG. 2 as an example, a computer-implemented process for projecting geographic coordinates into a coordinate space of a target image enabling navigation of the target image is presented. Processor unit 204 performs an initialization using a set of geographic reference points and receives a set of points in a coordinate space of a target image, receives a one-to-one mapping between the set of geographic reference points and the set of points in the coordinate space of the target image from communications unit 210, input/output unit 212 or storage devices 216. Processor unit 204 computes a triangulation of the reference points of each respective set of reference points, identifies a containing triangle represented in the triangulation in which an arbitrary geographic coordinate point is located, and identifies points in a space of the target image corresponding to vertices of the containing triangle. Processor unit 204 further interpolates a location within the containing triangle to form a resulting location and superimposes the resulting location onto the target image. The target image is presented on display 214.

In another example, a computer-implemented process, using program code 218 stored in memory 206 or as a computer program product 222, for projecting geographic coordinates into a coordinate space of a target image enabling navigation of the target image comprises a computer recordable storage media, such as computer readable media 220, containing computer executable program code stored thereon. The computer executable program code comprises computer executable program code for projecting geographic coordinates into a coordinate space of a target image enabling navigation of the target image.

In another illustrative embodiment, the process for projecting geographic coordinates into a coordinate space of a target image enabling navigation of the target image may be implemented in an apparatus comprising a communications fabric, a memory connected to the communications fabric, wherein the memory contains computer executable program code, a communications unit connected to the communications fabric, an input/output unit connected to the communications fabric, a display connected to the communications fabric, and a processor unit connected to the communications fabric. The processor unit of the apparatus executes the computer executable program code to direct the apparatus to perform the process for projecting geographic coordinates into a coordinate space of a target image enabling navigation of the target image.

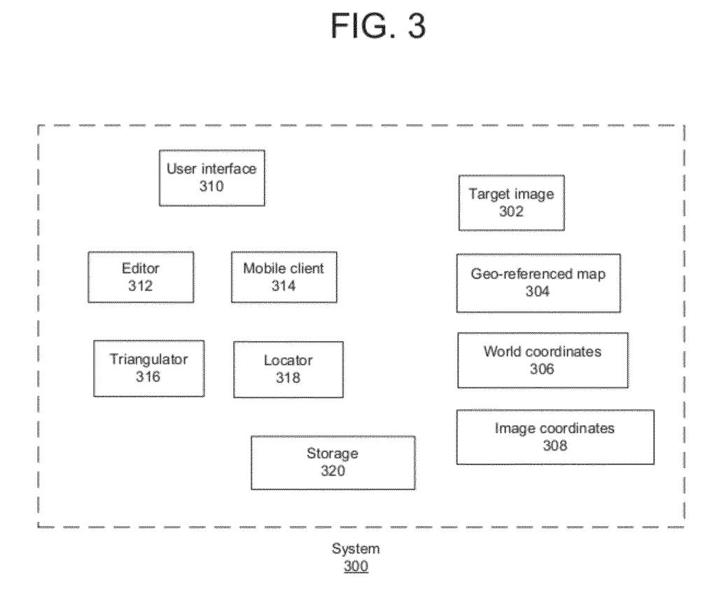

With reference to FIG. 3, a block diagram of a projection system, in accordance with various embodiments of the disclosure is presented. System 300 is an example of a system enabling arbitrary geographic coordinates to be projected into the coordinate space of a target image providing a capability for navigating on an original undistorted image. Embodiments of the disclosed projection process enables a mesh of points on the target image and a corresponding mesh of points on a geo-referenced map, and then use the correspondence between these two meshes to project geographic coordinates into the coordinate space of the target image.

System 300 comprises a number of components supported by a data processing system such as data processing system 200 of FIG. 2 including target image 302, geo-referenced map 304, world coordinates 306, image coordinates 308, user interface 310, editor 312, mobile client 314, triangulator 316, locator 318, and storage 320.

Target image 302 represents an image, usually a map, a user desires to have a current position superimposed upon to aid in the user's navigation. The target image is in digital form. The target image does not need to be ortho-corrected, or to have a known projection, or even to have a uniform scale across it.

Geo-referenced map 304 represents a map of an area that has defined an existence in physical space. The map has established locations in terms of map projections or coordinate systems. The spatial location of geographical features may be defined using coordinates for points including place names or street addresses.

World coordinates 306 are coordinates representing a location in the real world, for example coordinates obtained from a global positioning system (GPS) unit. World coordinates 306 are expressed as a (longitude, latitude) pair.

Image coordinates 308 are coordinates representing a location on target image 302. Image coordinates 308 are expressed as an (x, y) pair.

User interface 310 supports embodiments of desktop devices including editor 312 and mobile devices including mobile client 314. User interface 310 enables presentation of target image 302 with a navigation capability for a user.

Triangulator 316 provides a capability to calculate coordinate positions associated with pairs of corresponding points between target image 302 and geo-referenced map 304. Triangulator 316 typically comprises a set of algorithms suited to calculate and project geographic coordinate information using target image 302 and geo-referenced map 304, Locator 318 provides a capability to determine and superimpose a location of a user onto target image 302 to provide current position information and location.

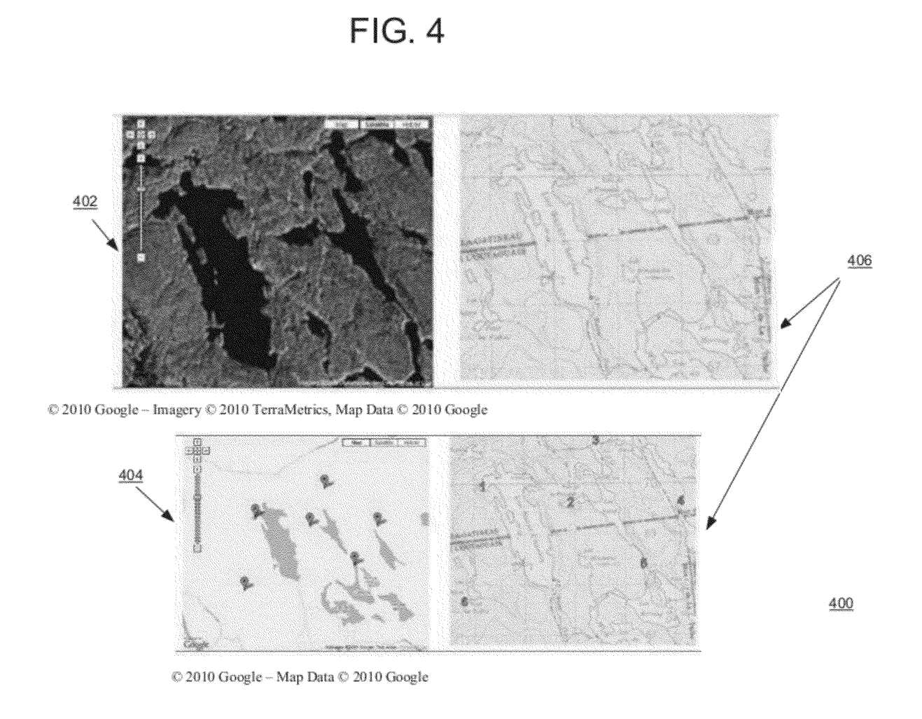

With reference to FIG. 4, pictorial representation of a geo-referenced map and an arbitrary map, in accordance with one embodiment of the disclosure is presented. Maps 400 represent an example of a geo-referenced map and a corresponding arbitrary map.

Map 402 and map 404 are examples of geo-referenced maps. Map 402 is a satellite image that has been geo-referenced. Map 404 is a generated image of map 402 in two dimensional view. Map 406 is an arbitrary map corresponding to both map 402 and map 404. Position indicators on map 404 have corresponding position indicators 1 through 6 on map 406. A position indicator on map 404 is matched with a corresponding position indicator on map 406 to form a corresponding pair of position indicators. Map 406 represents a target image, such as target image 302 of system 300 of FIG. 3. As previously described map 406 may represent a topographic map, photo, hand drawn map or other suitable map.

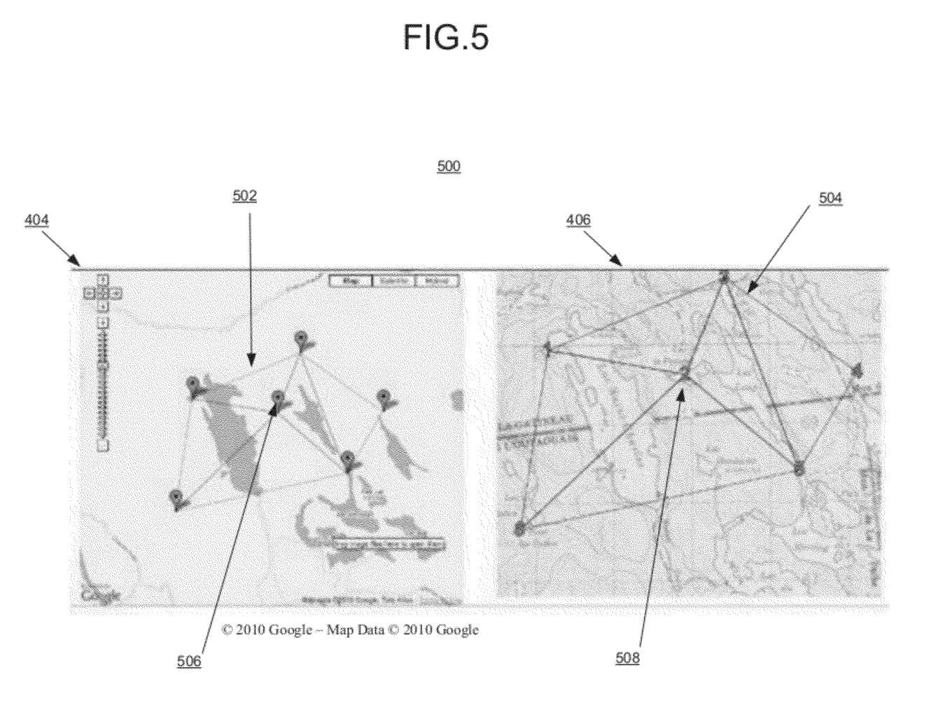

With reference to FIG. 5, a pictorial representation of a geo-referenced map and an arbitrary map, in accordance with one embodiment of the disclosure is presented. Maps 500 represent an example of a geo-referenced map and a corresponding arbitrary map having a triangulation operation performed. The triangulation operation identifies edges to form a triangulated mesh 502 on map 404 and a triangulated mesh 504 on map 406. Point 506 represents a same location on map 404 as point 508 on map 406. Point 506 and point 508 form a pair of corresponding points referencing a same location on respective maps.

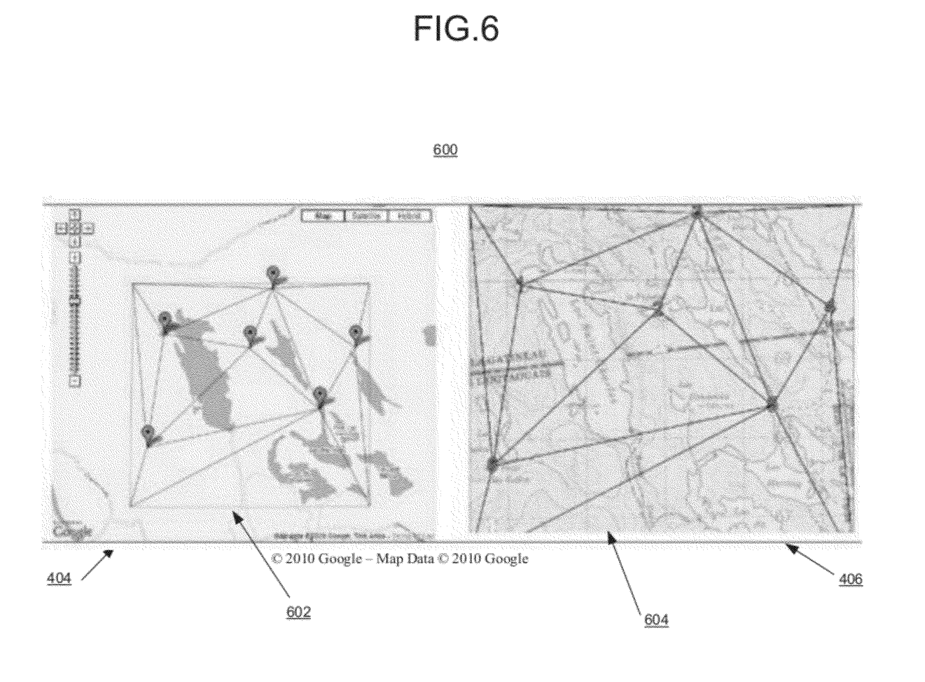

With reference to FIG. 6, a pictorial representation of a geo-referenced map and an arbitrary map, in accordance with one embodiment of the disclosure is presented. Maps 600 represent an example of a geo-referenced map and a corresponding arbitrary map having a bounding box defined resulting from a triangulation operation on respective corresponding location points. The bounding box identifies a outer boundary of location points defined using the triangulated mesh 502 on map 404 and the triangulated mesh 504 on map 406 of map 500 of FIG. 5. Box 602 represents a bounding box on map 404 with a corresponding bounding box of box 604 on map 406. Bounding box 602 and bounding box 604 reference the same locations on respective maps.

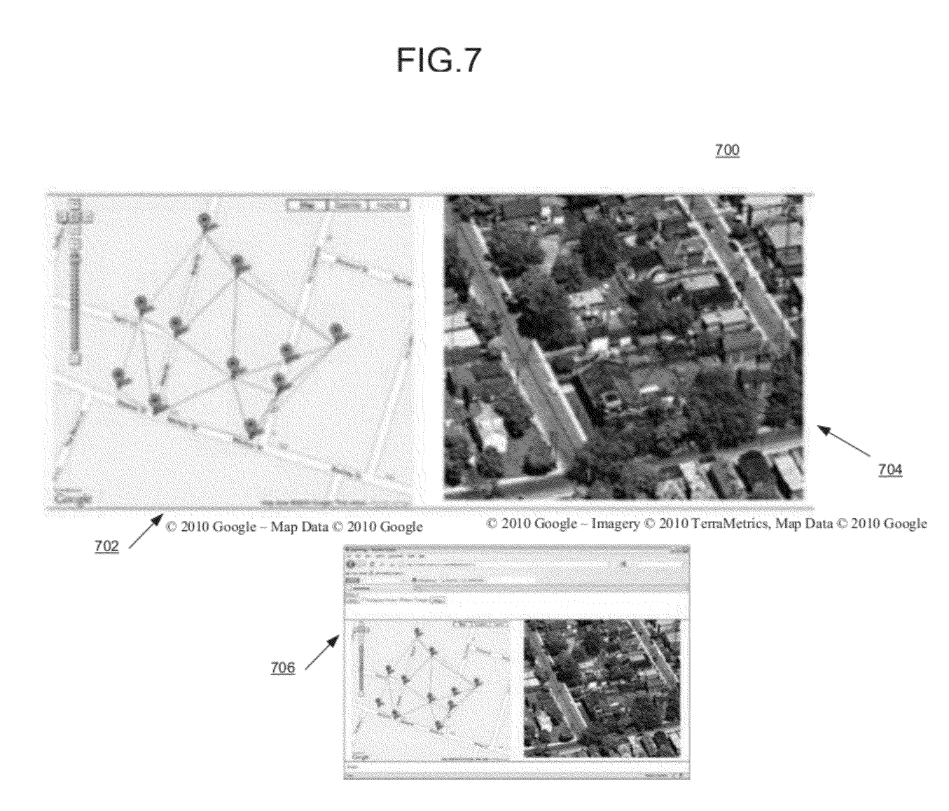

With reference to FIG. 7, a pictorial representation of a geo-referenced map and an arbitrary map, in accordance with one embodiment of the disclosure is presented. Maps 700 represent an example of a geo-referenced map and a corresponding arbitrary map having a bounding box defined and an example of user interface view of the corresponding maps. Map 702 represents a bounding box identifying an outer boundary of location points defined using a triangulated mesh on a geo-referenced map. Map 704 represents a corresponding triangulated mesh on a photographic representation of the same spatial area. Interface portion 706 represents a combined view of map 702 with map 704 as may be presented in browser window of a data processing system. Interface portion 706 is representative of a user interface 310, presenting a session using editor 312 of system 300 of FIG. 3.

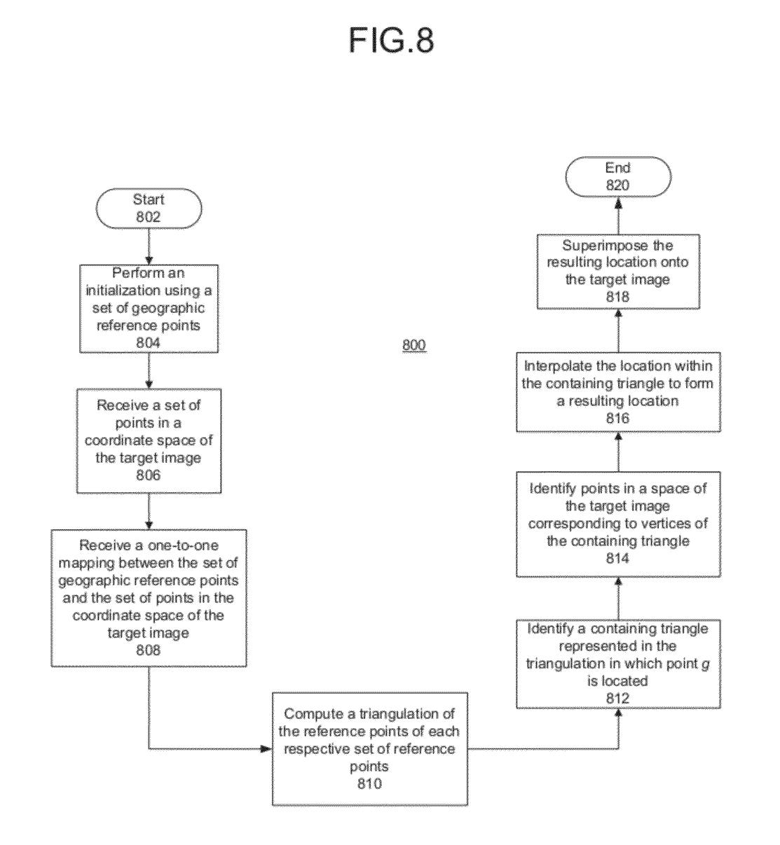

With reference to FIG. 8, a flowchart of a process for projecting geographic coordinates into a coordinate space of a target image, in accordance with an embodiment of the disclosure is presented. Process 800 represent an example of a process for projecting geographic coordinates of a geo-referenced map into a coordinate space of a target image of a corresponding arbitrary map using system 300 of FIG. 3.

Process 800 begins (step 802) and performs an initialization using a set of geographic reference points (world coordinates), each consisting of a longitude and a latitude value, represented as a set G={g|g=(longitude, latitude)}(step 804). The set of geographic reference points is typically provided by a user but may be provided as a predetermined set of input values. In this example, a user provides the input specifications.

Process 800 receives a set of points in the coordinate space of the target image, specified by the user, each point consisting of an x and a y value represented as a set

I={i|i=(x, y)} (step 806). Process 800 receives a one-to-one mapping between the set of geographic reference points and the set of points in the coordinate space of the target image as determined by the user (step 808). The mapping is represented by the function m:G→I.

The provision of input data may be made available, for example, by providing a user interface in which a target image is placed beside a geo-referenced map and the user is allowed to choose pairs of points, one point on each map, corresponding to a same geographic location.

Process 800 computes a triangulation of the reference points of each respective set of reference points (step 810). For example, a Delaunay triangulation DT(G) of the points in G may be calculated. The triangles of the computation are expressed as vertex triples represented as DT(G)={(g₁, g₂, g₃)|gεG}.

Using the computed triangulation, an arbitrary geographic coordinate g can be projected into the coordinate space of the image using process 800. Process 800 identifies in which triangle represented by a triplet (g₁, g₂, g₃) in the Delaunay triangulation DT(G) point g is located (step 812). A determination may be made using any point-location algorithm, for example, a hierarchy of triangles taught by Kirkpatrick or Guibas and an edge-walking algorithm as taught by Stolfi. Using a mapping m process 800 identifies points in the space of the target image corresponding to the vertices of the containing triangle represented as m(g₁)=i₁ (step 814).

Given the original triangle defined as (g₁, g₂, g₃) and the contained point g, process 800 interpolates the location i within the triangle defined as (i₁, i₂, i₃) (step 816). The resulting location i=(xᵢ, yᵢ) is the desired location in the coordinate space of the target image. Process 800 uses the resulting location to superimpose the location of the user onto the target image (step 818). Process 800 terminates thereafter (step 820).

In an illustrative embodiment, a user may navigate the full area of the target image. When the scale and projection of the target image is somewhat regular a possibility to extrapolate the corners of the target image back to geographic (‘world’) coordinates exists. The pairs of coordinates can then be added to the triangulation and used during navigation.

For example, for each corner i_{c}=(x−_{c}, y_{c}) find the nearest three points represented as i₁=(x₁, y₁), i₂=(x₂, y₂), i₃=(x₃, y₃). Reorder the three points such that |x₁−x₂|>|x₁−x₃|≧|x₂−x₃|. Using a reverse mapping defined as m′: I→G, locate the points {g₁, g₂|gεG} that correspond to {i₁, i₂|iεI} use the correspondence (longitude₁−longitude₂))/(x₁−x₂)=(longitude₁−longitude_{c})/(x₁−x_{c}) to find longitude_{c} repeat the above steps to find latitude_{c}.

The example algorithm just described produces geographic coordinates for four points corresponding to corners of the target image. The four points can then be included in the previously described triangulation calculation, and used during point location enabling the user to navigate the full area of the target image.

In another illustrative embodiment, in consecutive iterations of the point location algorithm, the point being located (usually corresponding to the location of the user) will likely not have changed very much. Therefore, a first test for containment in the triangle in which the point was located during a last iteration is useful, because most of the time a subsequent point will be found in the same triangle. When the point is not found in the same triangle, then a nearest edge should be used to start an edge-walking point location algorithm.

In another illustrative embodiment, the projection technique described is suited to dynamic updates. For example, a user ‘on the ground’ with a mobile device could adjust either the geographic points in G or the image coordinates Ito fine-tune the projection. Adjusting image coordinates in I requires a mobile user interface enabling reference points to be added, moved or removed relative to the target image. Adjusting corresponding geographic coordinates in C requires a mobile user interface enabling the user to specify that a current location should be used as a new geographic coordinate for a given point.

In another illustrative embodiment, in addition to fine-tuning an existing set of points, the disclosed projection technique could be used to create a projection entirely from a mobile device, for example without an initial desktop setup. A mobile user, for example, could acquire a map through a mobile device, by downloading or by taking a photo with a camera in the mobile device. The mobile user then creates the projection dynamically by physically traversing the area covered by the map to register the control points.

Thus is presented in an illustrative embodiment a computer-implemented process for enabling navigation on arbitrary maps including paper maps, directions to cottages drawn on napkins, walking tour maps, ski hill maps, manufacturing plant air photos, historical photos and similar sources. An illustrative embodiment of the computer implemented process projects geographic coordinates into a coordinate space of a target image enabling navigation of the target image. In one illustrative embodiment, the computer-implemented process for projecting geographic coordinates into a coordinate space of a target image enabling navigation of the target image performs an initialization using a set of geographic reference points, receives a set of points in a coordinate space of a target image, receives a one-to-one mapping between the set of geographic reference points and the set of points in the coordinate space of the target image, computes a triangulation of the reference points of each respective set of reference points, identifies a containing triangle represented in the triangulation in which an arbitrary geographic coordinate point is located, identifies points in a space of the target image corresponding to vertices of the containing triangle, interpolates a location within the containing triangle to form a resulting location and superimposes the resulting location onto the target image.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing a specified logical function. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, and other software media that may be recognized by one skilled in the art.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed, Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A computer-implemented method for projecting geographic coordinates into a coordinate space of a target image enabling navigation of the target image, the computer-implemented method comprising:
performing an initialization using a set of geographic reference points;
receiving a set of points in the coordinate space of the target image;
receiving a one-to-one mapping between the set of geographic reference points and the set of points in the coordinate space of the target image;
computing a triangulation of the geographic reference points of each respective set of geographic reference points;
identifying a containing triangle represented in the triangulation in which an arbitrary geographic coordinate point is located;
identifying points in a space of the target image corresponding to vertices of the containing triangle;
interpolating a location within the containing triangle to form a resulting location; and
superimposing the resulting location onto the target image.

2. The computer-implemented method of claim 1, wherein receiving the one-to-one mapping between the set of geographic reference points and the set of points in the coordinate space of the target image further comprises:
using a user interface showing two maps side-by-side enabling a projection to be configured.

3. The computer-implemented method of claim 1, further comprising:
navigating a full area of the target image when a scale and projection of the target image is somewhat regular, wherein the navigating comprises extrapolating corners of the target image back to geographic coordinates and adding pairs of coordinates to the triangulation for use during navigation.

4. The computer-implemented method of claim 3, wherein extrapolating the corners further comprises:
finding a nearest three points represented as i₁=(x₁, y₁), i₂=(x₂, y₂), i₃=(x₃, y₃) for each corner i_{c}=(x_{-c}, y_{c});
reordering the three nearest points such that |x₁−x₂|>|x₁−x₃|≧|x₂−x₃|;
using a reverse mapping defined as m′: I→G to locate the points {g₁, g₂|gεG} that correspond to {i₁, i₂|iεI};
using a correspondence (longitude₁−longitude₂))/(x₁−x₂)=(longitude₁−longitude_{c})/(x₁−x_{c}) to find longitude_{c}; and
repeating the steps of finding, reordering, reverse mapping and using a correspondence to find latitude_{c}.

5. The computer-implemented method of claim 1, further comprising:
testing for containment in the containment triangle in which a point was located during a last iteration; and
responsive to a determination that the point is not found in a same triangle, using a nearest edge to start an edge-walking point location algorithm.

6. The computer-implemented method of claim 1, wherein superimposing the resulting location onto the target image further comprises:
acquiring a map through a mobile device; and
creating a projection dynamically by physically traversing an area covered by the map to register control points.

7. The computer-implemented method of claim 1, further comprises:
adjusting one geographic reference point in the set of geographic reference points; and
adjusting image coordinates in a set of image coordinates to fine-tune the projection, wherein adjusting the image coordinates uses a mobile user interface to add, move or remove reference points relative to the target image and adjusting corresponding geographic coordinates uses the mobile user interface to specify a current location for use as a new geographic coordinate for a given point.

8. A computer program product for projecting geographic coordinates into a coordinate space of a target image enabling navigation of the target image, the computer program product comprising:
a computer recordable-type media containing computer executable program code stored thereon, the computer executable program code comprising:
computer executable program code for performing an initialization using a set of geographic reference points;
computer executable program code for receiving a set of points in a coordinate space of a target image;
computer executable program code for receiving a one-to-one mapping between the set of geographic reference points and the set of points in the coordinate space of the target image;
computer executable program code for computing a triangulation of the geographic reference points of each respective set of geographic reference points;
computer executable program code for identifying a containing triangle represented in the triangulation in which an arbitrary geographic coordinate point is located;
computer executable program code for identifying points in a space of the target image corresponding to vertices of the containing triangle;
computer executable program code for interpolating a location within the containing triangle to form a resulting location; and
computer executable program code for superimposing the resulting location onto the target image.

9. The computer program product of claim 8, wherein computer executable program code for receiving the one-to-one mapping between the set of geographic reference points and the set of points in the coordinate space of the target image further comprises:
computer executable program code for using a user interface showing two maps side-by-side enabling a projection to be configured.

10. The computer program product of claim 8, further comprising:
computer executable program code for navigating a full area of the target image when a scale and a projection of the target image is somewhat regular, wherein the navigating comprises extrapolating corners of the target image back to geographic coordinates and adding pairs of coordinates to the triangulation for use during navigation.

11. The computer program product of claim 10, wherein computer executable program code for extrapolating the corners further comprises:
computer executable program code for finding the nearest three points represented as i₁=(x₁, y₁), i₂=(x₂, y₂), i₃=(x₃, y₃) for each corner i_{c}=(x_{-c}, y_{c});
computer executable program code for reordering the three nearest points such that |x₁−x₂|>|x₁−x₃|≧|x₂−x₃|;
computer executable program code for using a reverse mapping defined as m′: I→G, to locate points {g₁, g₂|gεG} that correspond to {i₁, i₂|iεI};
computer executable program code for using a correspondence (longitude₁−longitude₂))/(x₁−x₂)=(longitude₁−longitude_{c})/(x₁−x_{c}) to find longitude; and
computer executable program code for repeating the steps of finding, reordering, reverse mapping and using a correspondence to find latitude_{c}.

12. The computer program product of claim 8, further comprising:
computer executable program code for testing for containment in the containment triangle in which a point was located during a last iteration; and
computer executable program code responsive to a determination that the point is not found in a same triangle, for using a nearest edge to start an edge-walking point location algorithm.

13. The computer program product of claim 8, wherein computer executable program code for superimposing the resulting location onto the target image further comprises:
computer executable program code for acquiring a map through a mobile device; and
computer executable program code for creating a projection dynamically by physically traversing an area covered by the map to register control points.

14. The computer program product of claim 8, further comprises:
computer executable program code for adjusting one geographic reference point in the set of geographic reference points; and
computer executable program code for adjusting image coordinates in a set of image coordinates to fine-tune the projection, wherein adjusting the image coordinates uses a mobile user interface to add, move or remove reference points relative to the target image and adjusting corresponding geographic coordinates uses the mobile user interface to specify a current location for use as a new geographic coordinate for a given point.

15. An apparatus for projecting geographic coordinates into a coordinate space of a target image enabling navigation of the target image, the apparatus comprising:
a communications fabric;
a memory connected to the communications fabric, wherein the memory contains computer executable program code;
a communications unit connected to the communications fabric;
an input/output unit connected to the communications fabric;
a display connected to the communications fabric; and
a processor unit connected to the communications fabric, wherein the processor unit executes the computer executable program code to direct the apparatus to:
perform an initialization using a set of geographic reference points;
receive a set of points in a coordinate space of a target image;
receive a one-to-one mapping between the set of geographic reference points and the set of points in the coordinate space of the target image;
compute a triangulation of the geographic reference points of each respective set of geographic reference points;
identify a containing triangle represented in the triangulation in which an arbitrary geographic coordinate point is located;
identify points in a space of the target image corresponding to vertices of the containing triangle;
interpolate a location within the containing triangle to form a resulting location; and
superimpose the resulting location onto the target image.

16. The apparatus of claim 15, wherein the processor unit executes the computer executable program code to further direct the apparatus to:
navigate a full area of the target image when a scale and projection of the target image is somewhat regular, wherein the navigating comprises extrapolating corners of the target image back to geographic coordinates and adding pairs of coordinates to the triangulation for use during navigation.

17. The apparatus of claim 16, wherein the processor unit executes the computer executable program code to extrapolate the corners further directs the apparatus to:
find a nearest three points represented as i₁=(x₁, y₁), i₂=(x₂, y₂), i₃=(x₃, y₃) for each corner i_{c}=(x_{-c}, y_{c});
reorder the three nearest points such that |x₁−x₂|>|x₃|≧|x₂−x₃|;
use a reverse mapping defined as m′: I→G to locate the points {g₁, g₂|gεG} that correspond to {i₁, i₂|iεI};
use a correspondence (longitude₁−longitude₂))/(x₁−x₂)=(longitude₁−longitude_{c})/(x₁−x_{c}) to find longitude_{c}; and
repeat the steps of finding, reordering, reverse mapping and using a correspondence to find latitude_{c}.

18. The apparatus of claim 15, the processor unit further executes the computer executable program code to direct the apparatus to:
test for containment in the containment triangle in which a point was located during a last iteration; and
responsive to a determination that the point is not found in a same triangle, use a nearest edge to start an edge-walking point location algorithm.

19. The apparatus of claim 15, wherein the processor unit further executes the computer executable program code to superimpose the resulting location onto the target image further directs the apparatus to:
acquire a map through a mobile device; and
create a projection dynamically by physically traversing an area covered by the map to register control points.

20. The apparatus of claim 15, wherein the processor unit further executes the computer executable program code to direct the apparatus to:
adjust one geographic reference point in a set of geographic reference points; and
adjust image coordinates in a set of image coordinates to fine-tune the projection, wherein adjusting the image coordinates uses a mobile user interface to add, move or remove reference points relative to the target image and adjusting corresponding geographic coordinates uses the mobile user interface to specify a current location for use as a new geographic coordinate for a given point.
